(19) United States
(12) Patent Application Publication
(10) Pub. No.: US 2021/0346234 A1
(43) Pub. Date: Nov. 11, 2021

(54) PROCESS FOR IMPROVING APPEARANCE AND REGENERATION AND TREATMENT DEVICE

(71) Applicant: Rudolf WEYERGANS, Duren (DE)

(72) Inventor: Rudolf WEYERGANS, Duren (DE)

(21) Appl. No.: 16/869,908

(22) Filed: May 8, 2020

(51) Int. Cl. A61H 9/00

(52) U.S. Cl. CPC A61H 9/0057; A61H 2201/5033; A61H 2201/5071; A61H 2209/00

(57) ABSTRACT

A process for the cosmetic improvement of physical appearance and for the non-therapeutic acceleration of regeneration after physical stress includes intermittent vacuum therapy with intermittent compression therapy, in which the pressure difference between the negative pressure and an overpressure is at the same time set, depending on the condition of the person's tissues, to a value between 30 mbar and 80 mbar, but preferably between 30 and 50 mbar. The vacuum therapy and compression therapy are each carried out in a chamber for admitting the lower limbs or the lower limbs and parts of the abdomen of a person that can be sealed gas-tight and is connected by a gas-flow conduit to at least one turbo machine to alternately generate the negative pressure and the overpressure in the chamber.

### BACKGROUND OF THE INVENTION

The invention relates to a process for improving physical appearance and for accelerating regeneration after physical stress, in which at least one limb of a person is admitted into a chamber connected to at least one turbo machine, which is then sealed gas-tight. The invention also relates to a treatment device for executing the process.

A process for improving physical appearance when cellulite is present is disclosed in EP 1 002 510 B 1. Lifestyle-related local accumulation of fat—also referred to as depot fat—develops as a result of poor diet and inadequate exercise in people of increasingly young age. The accumulation of fat is often accompanied by cellulite, which is ultimately characterized by distended fat cells in which deposits of unwanted metabolic by-products build up. Cellulite is understood here as meaning impairment of the local lymphatic circulation brought about by inadequate muscle-pump function. As a gentle means of improving physical appearance when cellulite is present, EP 1 002 510 B1 proposes admitting the lower limbs or the lower limbs and parts of the abdomen of a person into a chamber connected to at least one turbo machine, i.e., compressor, which is then sealed gas-tight, wherein the pressure in the chamber is reduced by 35-80 mbar relative to ambient atmospheric pressure and alternates between the ambient atmospheric pressure and reduced pressure. An alternative solution that has been described is for the pressure in the chamber to be alternately reduced by 35-80 mbar and increased by 20-60 mbar relative to ambient atmospheric pressure.

EP 1249 217 A1 discloses a process for increasing a person's physical performance, wherein all or part of the body of the person is admitted into a chamber connected to at least one pump, which is then sealed gas-tight. The pressure in the chamber is alternately reduced by 20 to 80 mbar relative to ambient atmospheric pressure and increased 10 to 40 mbar relative to ambient atmospheric pressure.

Regeneration is understood as meaning processes that result in the restoration of a state of physiological equilibrium after physical stress, especially sporting activities. The need for regeneration is influenced by the intensity and duration of the stress. The metabolites (metabolic breakdown products such as lactate) formed in greater amounts under conditions of stress need to be removed and completely broken down or excreted. If this does not occur, impairment of performance results. The swiftness of regeneration is influenced by the athlete's condition and in particular by metabolic rate, physical constitution and fitness levels. Regeneration can be additionally accelerated by active and passive regeneration measures. Examples of active measures are cooling down, stretching exercises, relaxation exercises and targeted nutrition. Examples of passive measures are massages, sauna sessions and heat and cold treatments.

### BRIEF SUMMARY OF THE INVENTION

Based on the above-described prior art, an object of the present invention is to provide a process not only for improving physical appearance, but also for accelerating regeneration after physical stress, that has a particularly effective regenerative effect.

The object is achieved based on a combination of intermittent vacuum therapy with intermittent compression therapy, in which the pressure difference between the negative pressure and an overpressure is at the same time set, depending on the condition of the person's tissues, to a value between 30 mbar and 80 mbar, but preferably between 30 and 50 mbar. It has also been found that the principal focus of the process needs to be either intermittent vacuum therapy or intermittent compression therapy. Irrespective of the chosen principal focus of the process, it has additionally been found that a pressure difference of between 30 and 50 mbar after physical stress is completely sufficient to achieve the desired acceleration of regeneration without placing too much stress on the connective tissue and/or vascular system.

The principal focus of the process for improving physical appearance and for accelerating regeneration after physical stress according to a first embodiment is intermittent vacuum therapy, in which the negative pressure is not more than 70 mbar below, and the overpressure not more than 10 mbar above, ambient atmospheric pressure. The higher negative pressure in relation to the overpressure favors vascular dilatation, arterial blood flow and the absorption of metabolic breakdown products. The subsequent increase in pressure in the chamber to an overpressure of not more than 10 mbar while maintaining a minimum pressure difference between negative pressure and overpressure of 30 mbar and not more than 80 mbar, but preferably 50 mbar, produces the desired lymph drainage and removal of metabolic breakdown products to the filter organs. The minimal compression in the combination with the minimum pressure difference results in effective removal of metabolic breakdown products, thereby promoting swift regeneration after sporting activities and at the same time improving the external appearance of the tissue, particularly when cellulite is present. The minimal overpressure allows the process to be used even when veins and lymph vessels are weak.

The principal focus of the process for improving physical appearance and for accelerating regeneration after physical stress according to a second embodiment is intermittent compression therapy, in which the negative pressure is not more than 10 mbar below, and the overpressure not more than 70 mbar above, ambient atmospheric pressure. The higher overpressure in relation to the negative pressure favors venous return and the removal of metabolic breakdown products. The subsequent decrease in pressure in the chamber to a negative pressure of not more than 10 mbar while maintaining a minimum pressure difference between negative pressure and overpressure of 30 mbar and not more than 80 mbar, but preferably 50 mbar, produces the desired lymphatic drainage and removal of metabolic breakdown products to the filter organs. The minimal negative pressure in the combination with the compression and the minimum pressure difference results in effective removal of metabolic breakdown products, thereby promoting swift regeneration after sporting activities and at the same time improving the external appearance of the tissue, particularly when cellulite is present. The minimal negative pressure allows the process to be used even when connective tissue is weak and cellulite is present.

The pressure difference between the negative pressure and the overpressure is preferably between 30 mbar and 50 mbar irrespective of whether the principal focus of the process is intermittent vacuum therapy or compression therapy. If cellulite is present—characterized by weak connective tissue and low back-pressure from skin and connective tissue—a pressure difference of just 30 mbar is sufficient to maintain the removal of metabolic breakdown products after physical stress. In athletes—characterized by relatively firm connective tissue and correspondingly higher back-pressure from skin and fatty tissue—a higher pressure difference of up to 50 mbar is necessary to maintain the removal of metabolic breakdown products. The rule that can be inferred is that the weaker the connective tissue, the lower the chosen pressure difference should be, and the firmer the connective tissue, the higher the chosen pressure difference should be within the specified range between 30 and 50 mbar.

Regeneration after physical exercise may be advantageously achieved by the process according to the invention without joints and tendons being stressed by cool-down training, in particular without having to accept the pain that often comes with this.

### BRIEF DESCRIPTION OF THE DRAWINGS

In the drawings:

FIG. 1 is a flow diagram of the process according to an embodiment of the invention; and

FIG. 2 is a block diagram of the components of the treatment device according to an embodiment of the invention.

### DETAILED DESCRIPTION OF THE PREFERRED EMBODIMENTS

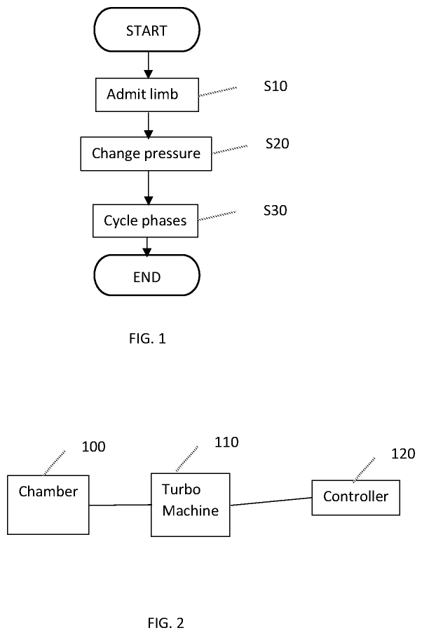

A process according to an embodiment of the invention is described with reference to FIGS. 1 and 2. A limb of a person to be treated is inserted in a chamber 100 (step S10). The pressure in the chamber alternates between a negative pressure and an overpressure (step S20). By defining the time periods during which the negative pressure and the overpressure are maintained, before the negative pressure is raised to an overpressure/the overpressure is lowered to a negative pressure, the principal focus of the effect of the process according to the invention may be varied according to first, second, and third phases as follows:

a first phase including short time periods of negative pressure for 5-9 seconds and overpressure for 3-5 seconds that boosts arterial blood flow;

a second phase including medium-length time periods of negative pressure for 11-17 seconds and overpressure for 5-9 seconds that boosts venous return; and

a third phase including long time periods of negative pressure for 17-23 seconds and overpressure for 7-12 seconds that boosts lymphatic return.

The optimal time periods for boosting arterial blood flow were determined by thermography, TcPO2 measurement (oxygen content of blood) and acral pulsation.

The optimal time periods for boosting venous return were determined by Doppler ultrasound, duplex ultrasonography and LRR (light reflection rheography).

The optimal time periods for boosting lymphatic return were determined by lymphofluoroscopy with indocyanine green as contrast medium, impedance measurement and ultrasonography.

By cycling the phases for maintaining the negative pressure and the overpressure as defined by the above short time periods, medium-length time periods and long time periods within a time interval in accordance with the invention, in particular a time interval of between two to ten minutes (step S30), the principal focus of the effect of the process can be successively changed, thereby achieving a particularly effective regenerative effect while at the same time improving physical appearance, and the appearance of the skin in particular. In routine use, the phases defining the time periods for maintaining the negative pressure and the overpressure may be sequentially changed from short to long, with the result that a boost to arterial blood flow is initially favored, followed by a boost to venous return and finally a boost to lymphatic return. The cycle then starts all over again.

The negative pressure, the overpressure and the time periods for maintaining the negative pressure and the overpressure are controlled by an electronic controller 120 for at least one turbo machine 110, i.e., a compressor or any other machine or machines which can be used to reduce/increase the pressure in the chamber 100.

The electronic controller 120 is a constituent of a treatment device according to the present invention. The chamber 100 of the treatment device for admitting at least one limb or the lower limbs or the lower limbs and parts of the abdomen of a person has an entrance opening that, by means of a closure, can be sealed gas-tight against the lower limb(s) or abdomen of the person.

One such closure element is disclosed per se in DE 199 12 611 C2 and comprises a flexible tube composed of a largely gas-tight material that is attached at either of the two ends to the chamber. The tube is twisted by a ring attached to the other end of the tube until it is pressing firmly against the limbs or abdomen of the person.

A chamber for admitting the lower half of the body of a person having an entrance opening that can be sealed gas-tight against the person's trunk by a closure element has likewise previously been disclosed per se in WO 2015/043878 A1.

In addition, DE 10 2013 11 208 A1 discloses a treatment device comprising a first chamber suitable for admitting the lower half of the body of a person and a second chamber suitable for admitting an upper limb, with both chambers having entrance openings that can be sealed gas-tight against the person's upper limb or trunk by means of a closure element.

The negative pressure/overpressure in the chamber is generated by the turbomachine, for example one having at least one lateral air blower that is driven by a three-phase motor. The controller is able to reverse the direction of rotation of the three-phase motor so that the lateral air blower is set up for generation of both the negative pressure and the overpressure. The controller can be used to change the duration of the time periods during which the negative pressure/overpressure in the chamber is exerted. Alternatively, the chamber 100 may be connected to two turbo machine, with the negative pressure generated by a first turbo machine and the overpressure by a second turbo machine.

The process according to the invention is elucidated in more detail hereinbelow with reference to exemplary embodiments.

### Exemplary Embodiment 1

The lower limbs and parts of the abdomen of a person with weak connective tissue are admitted in a gas-tight manner into a chamber in which the pressure relative to ambient atmospheric pressure was alternately increased to a negative pressure of 10 mbar below, and an overpressure of 20 mbar above, ambient atmospheric pressure.

The pressure difference was 30 mbar in accordance with the weak connective tissue. The treatment period was 30 minutes in total. During the treatment period, two treatment cycles of 15 minutes each were carried out. In each of these treatment cycles, the time periods for maintaining the negative pressure and the overpressure were changed after five minutes and 10 minutes. The time periods were changed in each cycle such that a boost to arterial blood flow was initially prioritized in the process, followed by a boost to venous return and finally a boost to lymphatic return.

After an appropriate training stimulus, the process according to the invention contributed to a measurable shortening of the regeneration time in athletes; restoration of performance was demonstrated by a bicycle ergometer test at a fixed time interval after the appropriate training stimulus with and without execution of the process.

1. A process for improving physical appearance and for accelerating regeneration after physical stress, comprising the steps of:
admitting at least one limb of a person into a chamber connected to at least one turbo machine, which is then sealed gas-tight; and
changing a pressure in the chamber by alternatingly reducing the pressure in the chamber to a negative pressure relative to ambient atmospheric pressure and increasing the pressure in the chamber to an overpressure relative to ambient atmospheric pressure,
wherein a pressure difference between the negative pressure and the overpressure is between 30 mbar and 80 mbar,
the negative pressure and the overpressure meet the following conditions:
the negative pressure is not more than 70 mbar below ambient atmospheric pressure and the overpressure not more than 10 mbar above the ambient atmospheric pressure, or
the negative pressure is not more than 10 mbar below ambient atmospheric pressure and the overpressure not more than 70 mbar above the ambient atmospheric pressure,
a first phase of the step of changing includes short time periods, in which the negative pressure is maintained in the chamber for 5-9 seconds and the overpressure is maintained for 3-5 seconds, to boost arterial blood flow,
a second phase of the step of changing includes medium length time periods, in which the negative pressure is maintained in the chamber for 11-17 seconds and the overpressure is maintained for 5-9 seconds, to boost venous return,
a third phase of the step of changing includes long time periods, in which the negative pressure is maintained in the chamber for 17-23 seconds and the overpressure is maintained for 7-12 seconds, to boost lymphatic return, and
the step of changing includes sequentially cycling between the first phase, the second phase, and the third phase within a time interval.

2. The process according to claim 1, wherein the negative pressure is not more than 70 mbar below ambient atmospheric pressure and the overpressure not more than 10 mbar above the ambient atmospheric pressure.

3. The process according to claim 1, wherein the negative pressure is not more than 10 mbar below ambient atmospheric pressure and the overpressure not more than 70 mbar above the ambient atmospheric pressure.

4. The process according to claim 1, wherein the pressure difference between the negative pressure and the overpressure is between 30 mbar and 50 mbar.

5. The process according to claim 1, wherein the time interval is between 2 to 10 minutes.

6. The process according to claim 1, wherein the step of admitting at least one limb of a person into a chamber includes admitting lower limbs or the lower limbs and a part of an abdomen of the person into the chamber.

7. A treatment device, comprising:
a chamber for admitting at least one limb or the lower limbs and parts of the abdomen of a person, wherein the chamber has an entrance opening with a closure that is capable of producing a gas-tight against the at least one limb or the abdomen of the person;
at least one turbo machine connected to the chamber for effecting a negative pressure or an overpressure relative to ambient atmospheric pressure; and
a controller configured to control the at least one turbo machine to change a pressure in the chamber by alternatingly reducing the pressure in the chamber to a negative pressure relative to ambient atmospheric pressure and increasing the pressure in the chamber to an overpressure relative to ambient atmospheric pressure,
wherein a pressure difference between the negative pressure and the overpressure is between 30 mbar and 80 mbar,
the negative pressure and the overpressure meet the following conditions:
the negative pressure is not more than 70 mbar below ambient atmospheric pressure and the overpressure not more than 10 mbar above the ambient atmospheric pressure, or
the negative pressure is not more than 10 mbar below ambient atmospheric pressure and the overpressure not more than 70 mbar above the ambient atmospheric pressure,
a first phase includes short time periods, in which the negative pressure is maintained in the chamber for 5-9 seconds and the overpressure is maintained for 3-5 seconds, to boost arterial blood flow,
a second phase includes medium length time periods, in which the negative pressure is maintained in the chamber for 11-17 seconds and the overpressure is maintained for 5-9 seconds, to boost venous return,
a third phase includes long time periods, in which the negative pressure is maintained in the chamber for 17-23 seconds and the overpressure is maintained for 7-12 seconds, to boost lymphatic return, and
the control unit is further configured to sequentially cycle between the first phase, the second phase, and the third phase within a time interval.
